(19) United States
(12) Patent Application Publication
(10) Pub. No.: US 2026/0065488 A1
(43) Pub. Date: Mar. 5, 2026

(54) IMAGE PROCESSING METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Xiaobin HU, Shenzhen (CN); Donghao LUO, Shenzhen (CN); Ying TAI, Shenzhen (CN); Chengjie WANG, Shenzhen (CN)

(21) Appl. No.: 19/320,869

(22) Filed: Sep. 5, 2025

Related U.S. Application Data
(63) Continuation of application No. PCT/CN2024/107496, filed on Jul. 25, 2024.

(30) Foreign Application Priority Data
Jul. 31, 2023 (CN) 202310951070.4

(51) Int. Cl. G06T 7/194; G06T 5/20; G06T 5/70; G06T 5/77; G06T 7/11; G06T 7/136

(52) U.S. Cl. CPC G06T 7/194; G06T 5/20; G06T 5/70; G06T 5/77; G06T 7/11; G06T 7/136; G06T 2207/10016; G06T 2207/20182; G06T 2207/20192; G06T 2207/20221

(57) ABSTRACT

An image processing method and apparatus, an electronic device, and a storage medium are provided. The method includes fusing a pre-segmentation mask corresponding to a green screen image and the green screen image to obtain a composite image comprising a foreground region and a background region, the foreground region having a target object, and the target object comprising a target part; determining a target region comprising the target part in the composite image; driving the target part in the target region; determining a target region comprising the driven target part as a driven image; extracting the driven target part in the driven image according to pixels of the driven image and pixels of the background region; and generating a target foreground region corresponding to the target object according to the driven target part and a region other than the target part in the foreground region.

### RELATED APPLICATIONS

This application is a continuation of PCT application No. PCT/CN2024/107496, filed on Jul. 25, 2024, which claims priority to Chinese Patent Application No. 2023109510704, filed with the China National Intellectual Property Administration on Jul. 31, 2023, and entitled “IMAGE PROCESSING METHOD AND APPARATUS, ELECTRONIC DEVICE, AND STORAGE MEDIUM”, which are incorporated herein by reference in their entirety.

### FIELD OF THE TECHNOLOGY

This application relates to the field of image processing technologies, and more specifically, to an image processing method and apparatus, an electronic device, and a storage medium.

### BACKGROUND OF THE DISCLOSURE

In the field of image processing technology, foreground extraction on a green screen image uses a segmentation mask determined by a deep learning model, to obtain a foreground region including a target object; then the target object in the foreground region is driven to perform a required action (for example, the mouth of a person in a background-replaced image is driven to present a shape of pronouncing the “a” sound), to obtain a driven image; and the segmentation mask before driving is then reused to segment the driven image, to obtain a foreground image with the target object as the foreground after the action driving.

However, after an action is performed on a specific part (for example, the mouth) of the target object in the background-replaced image, a region in which the target object is located in the driven image may not actually coincide with a region in which the target object is located in the original image. As a result, reusing the segmentation mask before driving to segment the driven image may easily lead to inaccuracy in the target object in the segmented foreground image, resulting in a poor effect of the foreground segmented from the driven image.

### SUMMARY

In view of this, embodiments of this application provide an image processing method and apparatus, an electronic device, and a storage medium.

One aspect of the embodiments of this application provides an image processing method. The method includes fusing a pre-segmentation mask corresponding to a green screen image and the green screen image to obtain a composite image comprising a foreground region and a background region, the foreground region having a target object, and the target object comprising a target part; determining a target region comprising the target part in the composite image; driving the target part in the target region; determining a target region comprising the driven target part as a driven image; extracting the driven target part in the driven image according to pixels of the driven image and pixels of the background region; and generating a target foreground region corresponding to the target object according to the driven target part and a region other than the target part in the foreground region.

Another aspect of the embodiments of this application provides an electronic device, including a processor and a memory, the one or more programs being stored in the memory and configured to be executed by the processor to implement the foregoing method.

An aspect of the embodiments of this application provides a non-transitory computer-readable storage medium, having a computer program stored therein, the computer program being suitable for being loaded by a processor to perform the method in the embodiments of this application.

An image processing method and apparatus, an electronic device, and a storage medium are provided in the embodiments of this application. In this application, a target part in a target region is driven, a target region including the driven target part is determined as a driven image, and the driven target part in the driven image is extracted by using pixels of the driven image and pixels of a background region instead of directly reusing a pre-segmentation mask corresponding to a green screen image before driving to segment the driven image. Therefore, this application avoids reusing the pre-segmentation mask to segment the driven image, preventing the segmented driven target part from including pixel points in the background region and avoiding missing some pixel points of the driven target part, thereby improving the accuracy of the segmented target foreground region, and further improving the effect of segmentation.

### BRIEF DESCRIPTION OF THE DRAWINGS

FIG. 1 is a schematic diagram of an application scenario to which embodiments of this application are applicable.

FIG. 2 is a flowchart of an image processing method according to an embodiment of this application.

FIG. 3 is a schematic diagram of a fusion process of a green screen image according to an embodiment of this application.

FIG. 4 is a schematic diagram of a fusion process of another green screen image according to an embodiment of this application.

FIG. 5 is a flowchart of an image processing method according to another embodiment of this application.

FIG. 6 is a flowchart of an image processing method according to still another embodiment of this application.

FIG. 7 is a schematic diagram of a background replacement procedure of a green screen image according to an embodiment of this application.

FIG. 8 is a block diagram of an image processing apparatus according to an embodiment of this application.

FIG. 9 is a structural block diagram of an electronic device configured to perform the image processing method according to the embodiments of this application.

### DESCRIPTION OF EMBODIMENTS

In the following descriptions, the related term “first/second” is merely intended to distinguish between similar objects rather than represent a particular sequence of the objects. A particular sequence or a chronological order indicated by “first/second” may be changed, so that embodiments of this application described herein can be implemented in a sequence other than the sequence illustrated or described herein.

Unless otherwise defined, all technical and scientific terms used herein have the same meanings as commonly understood by a person skilled in the art to which this application belongs. The terms used herein are merely for the purpose of describing embodiments of this application and not intended to limit this application.

“A plurality of” mentioned in this specification means two or more. The term “and/or” describes an association relationship between associated objects and represents that three types of relationships may exist. For example, A and/or B may represent the following three cases: only A exists, both A and B exist, and only B exists. A character “/” generally indicates an “or” relationship between associated objects.

This application discloses an image processing method and apparatus, an electronic device, and a storage medium, and relates to an artificial intelligence technology.

Artificial intelligence (AI) is a theory, a method, a technology, and an application system that use a digital computer or a machine controlled by the digital computer to simulate, extend, and expand human intelligence, perceive an environment, acquire knowledge, and use knowledge to acquire an optimal result. In other words, artificial intelligence is a comprehensive technology in computer science. It aims to understand the essence of intelligence and produce a new intelligent machine that can respond in a similar way as human intelligence. AI is to study design principles and implementation methods of various intelligent machines, to enable the machines to have functions of perception, reasoning, and decision-making.

The artificial intelligence technology is a comprehensive subject, and relates to a wide range of fields, including both hardware and software technologies. Basic technologies of artificial intelligence generally include technologies such as a sensor, a special-purpose artificial intelligence chip, cloud computing, distributed storage, a big data processing technology, an operation/interaction system, and mechatronics. AI software technologies mainly include several major directions such as a computer vision technology, a speech processing technology, a natural language processing technology, and machine learning/deep learning.

Machine learning (ML) is a multi-field interdiscipline that relates to a plurality of disciplines such as the probability theory, statistics, the approximation theory, convex analysis, and the algorithm complexity theory. The machine learning specializes in studying how a computer simulates or implements a human learning behavior to obtain new knowledge or skills, and reorganize an existing knowledge structure, to keep improving its performance. The machine learning is the core of AI, is a basic way to make the computer intelligent, and is applied to various fields of AI. The machine learning and the deep learning generally include technologies such as an artificial neural network, a belief network, reinforcement learning, transfer learning, inductive learning, and learning from demonstrations.

With the development of artificial intelligence (AI), a new virtual object, namely, a digital intelligent human, has emerged. The so-called “digital intelligent human” is an AI-powered virtual human capable of interacting with users and executing work tasks like a real person. The digital intelligent human integrates AI capabilities such as speech interaction, natural language understanding, and image recognition. With a more vivid appearance and more natural conversations with people, it transforms human-computer interaction from a simple dialogue tool into real communication. Compared with a digital human, the digital intelligent human is more intelligent and human-like.

Green screen segmentation technology is widely used in special effect generation in movies, television series, and games. It works by separating a subject from a background during filming, and then replacing the background with another image or video by using an image processing technology, to achieve a blended effect of a virtual background and a real foreground.

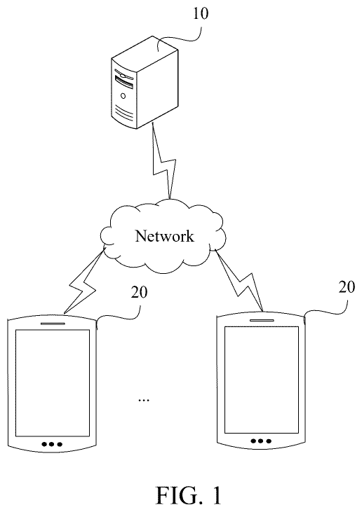

As shown in FIG. 1, an application scenario to which the embodiments of this application are applicable includes a terminal 20 and a server 10. The terminal 20 is in communication connection with the server 10 through a wired network or a wireless network. The terminal 20 may be a smartphone, a tablet computer, a notebook computer, a desktop computer, a smart appliance, an in-vehicle terminal, an aircraft, a wearable device terminal, a virtual reality device, or another terminal device that can display a page, or run another application (such as an instant messaging application, a shopping application, a search application, a game application, a forum application, or a map traffic application) that can invoke a page display application.

The server 10 may be an independent physical server, or may be a server cluster including a plurality of physical servers or a distributed system, or may be a cloud server that provides basic cloud computing services such as a cloud service, a cloud database, cloud computing, a cloud function, cloud storage, a network service, cloud communication, a middle ware service, a domain name service, a security service, a content delivery network (CDN), big data, and an artificial intelligence platform. The server 10 may be configured to provide a service to an application run by the terminal 20.

The terminal 20 may send a green screen image to the server 10. The server 10 may fuse a pre-segmentation mask corresponding to the green screen image and the green screen image to obtain a composite image, and determine, in the composite image, a target region including a target part, the target part being a part including a driven part in a target object; drive the target part in the target region, to determine a target region including the driven target part as a driven image; extract the driven target part in the driven image according to pixels of the driven image and pixels of the background region; and generate a target foreground region corresponding to the target object according to the driven target part and a region other than the target part in a foreground region. Finally, the server 10 determines, according to the target foreground region, a target background-replaced image after the background is replaced, and then returns the target background-replaced image to the terminal 20.

The green screen image may refer to an image that includes the target object with a green screen as a background, and the target object may be a person, an animal, a mechanical device, or the like. The target part refers to a part of the target object, and the driven part is a part of the target part. For example, when the target object is a person, the target part may be the head, and the driven part may be the face (which may include the mouth) in the head. For another example, when the target object is a dog, the target part may be hindquarters of the dog, and the driven part may be the tail.

The server 10 may determine the pre-segmentation mask of the green screen image by using a deep learning-based segmentation model. The server 10 may train an initial segmentation model by using sample images including the target object and mask images corresponding to the sample images, to obtain the segmentation model.

In another embodiment, the terminal 20 may be configured to perform the method of this application. After obtaining the target foreground region including the target object, the terminal 20 determines, according to the target foreground region, the target background-replaced image after the background is replaced.

The terminal 20 may also determine the pre-segmentation mask of the green screen image by using the deep learning-based segmentation model. After obtaining the segmentation model, the server 10 may store the segmentation model in a distributed cloud storage system, and the terminal 20 obtains the segmentation model from the distributed cloud storage system, to determine the pre-segmentation mask according to the segmentation model after obtaining the segmentation model.

For ease of description, in the following embodiments, an example in which image processing is performed by an electronic device is used for description.

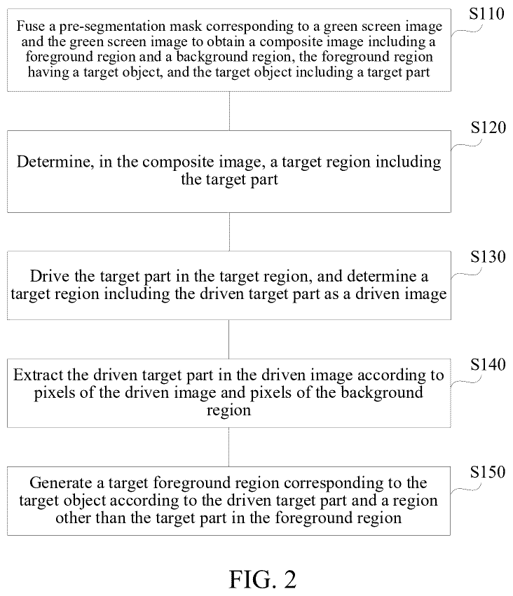

FIG. 2 is a flowchart of an image processing method according to an embodiment of this application. The method may be applied to an electronic device. The electronic device may be at least one of the terminal 20 or the server 10 in FIG. 1. The method includes the following operations.

S110: Fuse a pre-segmentation mask corresponding to a green screen image and the green screen image to obtain a composite image including a foreground region and a background region, the foreground region having a target object, and the target object including a target part.

The target object with a green screen as a background may be captured to obtain the green screen image; or the target object with a green screen background may be captured to obtain a captured video, and then any video frame or a specific video frame (the specific video frame may be, for example, the first frame of every ten frames) may be obtained from the captured video as the green screen image.

The green screen image uses the target object as a foreground, that is, a region in which the target object is located in the green screen image is used as the foreground, and a green screen region other than the region in which the target object is located in the green screen image is used as the background. In some embodiments, the pre-segmentation mask of the green screen image may be determined by using the segmentation model, and then the green screen image and the pre-segmentation mask corresponding to the green screen image are fused, to obtain the composite image. The region in which the target object is located in the composite image is the foreground region, and the green screen region other than the region in which the target object is located in the composite image is used as the background region.

The pre-segmentation mask (the mask is also referred to as an alphamask) corresponding to the green screen image includes a mask value corresponding to each pixel point in the green screen image. A pixel value of each pixel point in the green screen image may be multiplied by a corresponding mask value, to obtain the composite image, to implement fusion of the green screen image and the pre-segmentation mask corresponding to the green screen image.

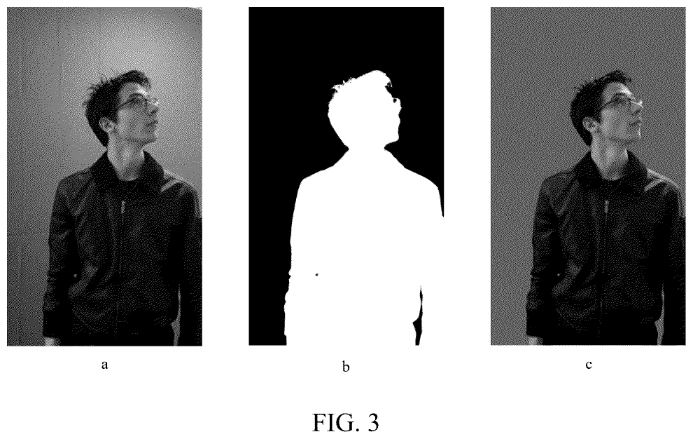

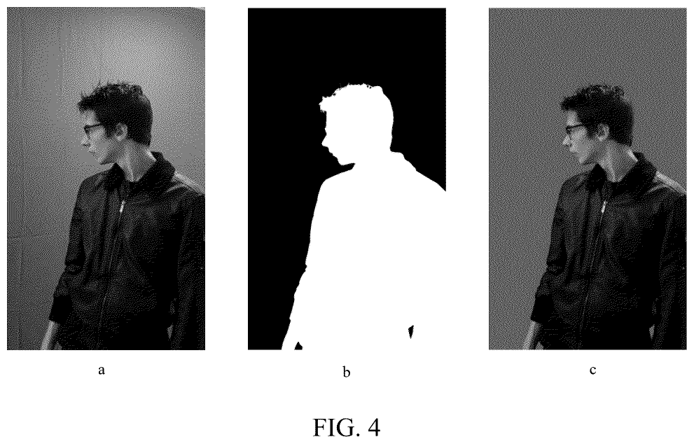

For example, as shown in FIG. 3, a in FIG. 3 is a green screen image, b in FIG. 3 is a pre-segmentation mask corresponding to the green screen image shown in a in FIG. 3, and c in FIG. 3 is a composite image obtained after a in FIG. 3 and b in FIG. 3 are fused. For another example, as shown in FIG. 4, a in FIG. 4 is another green screen image, b in FIG. 4 is a pre-segmentation mask corresponding to the green screen image shown in a in FIG. 4, and c in FIG. 4 is a composite image obtained after a in FIG. 4 and b in FIG. 4 are fused.

S120: Determine, in the composite image, a target region including the target part. The target part is a part including the driven part in the target object.

In this embodiment, the target part is a part of the target object, and the driven part is a part of the target part. A region in which the target part is located in the composite image is obtained as the target region. For example, when the target object in the composite image is a person, and the target part is the head, the driven part is the face (including the mouth), and a partial image including the head is obtained from the composite image as the target region.

S130: Drive the target part in the target region, to determine a target region including the driven target part as a driven image.

The target part includes a part that is driven. In this embodiment of this application, the part that is driven in the target part is referred to as a driven part. The driven part in the target region may be driven by using a preset target action, causing a pose of the driven part of the target object in the target region to change to a pose corresponding to the execution of the target action. When the pose of the driven part changes to the pose corresponding to the execution of the target action, an image of the target part is used as the driven image. That is, the driven image refers to the target region when the driven part performs the target action. The target action is an action that the driven part of the target object needs to perform. For example, when the driven part is the face (including the mouth) of a human, the target action may be an action for outputting a driving text, for example, an action for saying a driving text of the word “ni”, or an action for pronouncing the “a” sound.

For example, the target object is a person, the target part is the head, the driven part is the face (including the mouth), a pose of the face of the person in the target region is a head image when the person says “ni”, and the target action is an action for saying the word “jin”. The face of the person in the target region is driven according to the target action, to obtain the head image when the person says “jin” as the driven image.

S140: Extract the driven target part in the driven image according to pixels of the driven image and pixels of the background region.

A mask value of each pixel point in the driven image may be determined according to a difference between a pixel value of each pixel point in the driven image and a pixel value of the pixel point in the background region. The mask values of all pixel points in the driven image are aggregated, to obtain a segmentation mask for segmenting the driven target part, and then according to the segmentation mask for segmenting the driven target part, a region in which the target part is located is extracted from the driven image as the driven target part. The mask value is a value ranging from 0 to 1. Extracting a region in which the target part is located may refer to multiplying each pixel point in the driven image by the respective mask value.

The difference between the pixel value of each pixel point in the driven image and the pixel value of the pixel point in the background region may refer to a Euclidean distance, a cosine similarity, a squared Euclidean distance, or the like between the pixel value of each pixel point in the driven image corresponding to the target object and the pixel value of the pixel point in the background region.

In one embodiment, before S120, the method may include: obtaining a background-replaced image by replacing pixel values of pixel points in the background region in the composite image with a target pixel value. Correspondingly, S120 may include: determining, in the background-replaced image, the target region including the target part. S140 may include: extracting the driven target part in the driven image according to pixel values of pixel points of the driven image and the target pixel value.

The target pixel value may be a pixel value RGB (0, 124, 0) corresponding to a green screen color. The pixel values of the pixel points in the background region in the composite image may be replaced with the target pixel value, to obtain the background-replaced image corresponding to the composite image. The pixel values of the pixel points of the background in the background-replaced image are all the green screen color. Compared with the composite image, the pixel values of the pixel points of the background in the background-replaced image are more uniform, which improves the accuracy of the driven target part extracted according to the pixel values of the pixel points of the driven image and the target pixel value.

After the background-replaced image is obtained, the pixel values of the pixel points in the background region in the background-replaced image are all the target pixel value. In this case, the region including the target part may be determined in the background-replaced image as the target region, the target part in the target region is driven, and the target region including the driven target part is determined as the driven image. Then, the driven target part in the driven image may be extracted according to the pixels of the driven image and the target pixel value.

The mask value of each pixel point in the driven image may be determined according to a difference between the pixel value of each pixel point in the driven image and the target pixel value. The mask values of all pixel points in the driven image are aggregated, to obtain a segmentation mask for segmenting the driven target part, and then according to the segmentation mask for segmenting the driven target part, a region in which the target part is located is extracted from the driven image as the driven target part.

The target pixel value is a pixel value of pixel points representing the background in the background-replaced image. In addition, in operation S130, the driven part of the target object in the target region determined in the background-replaced image is driven based on the background-replaced image. Therefore, a pixel value of pixel points representing the background in the driven image is also the target pixel value. In this way, the segmentation mask for segmenting the driven target part is determined according to the difference between the pixel value of each pixel point in the driven image corresponding to the target object and the target pixel value. The segmentation mask for segmenting the driven target part may present the region in which the target part is located and the region in which the background is located in the driven image, which is equivalent to implementing foreground segmentation based on the difference between the pixel points in the foreground and the pixel points in the background in the driven image.

In one embodiment, before S140, the method may include: obtaining a region segmentation mask corresponding to the target region from the pre-segmentation mask corresponding to the green screen image; and fusing the region segmentation mask with the driven image, to obtain a fused driven image. S140 includes: extracting, in response to that the fused driven image does not meet a preset condition, the driven target part in the driven image according to the pixels of the driven image and the pixels of the background region. The preset condition indicates that the fused driven image does not include the pixel points in the background of the driven image and no pixel points of the target part are missing from the fused driven image.

After the driven image is obtained, a partial mask for segmenting the target part in the target region may be obtained from the pre-segmentation mask corresponding to the green screen image and used as the region segmentation mask. in response to that the target region is determined in the composite image, the region segmentation mask is a partial mask for segmenting the target region in the composite image. Similarly, in response to that the target region is determined in the background-replaced image, the region segmentation mask is a partial mask for segmenting the target region in the background-replaced image.

The region segmentation mask that corresponds to the target region that is in the pre-segmentation mask corresponding to the green screen image is directly reused, and the region segmentation mask is fused with the driven image, to obtain the fused driven image. Since the driven image is obtained according to the target region, the region segmentation mask for segmenting the target region has the same size as the driven image. Since the region segmentation mask includes the respective mask value of each pixel point in the target region, the region segmentation mask may include the respective mask value of each pixel point in the driven image. Fusing the region segmentation mask with the driven image may refer to multiplying each pixel point in the target region by the respective mask value.

If the fused driven image does not meet the preset condition, it indicates that the fused driven image includes the pixel points in the background of the driven image or the pixel points of the target part are missing from the fused driven image. In this case, processing continues according to the method of S140 of this application. The inclusion of the pixel points in the background of the driven image in the fused driven image may be caused by the driven target part becoming smaller, and the missing of the pixel points of the target part from the fused driven image may be caused by the driven target part becoming larger.

If the fused driven image meets the preset condition, it indicates that the fused driven image does not include the pixel points in the background of the driven image or no pixel points of the target part are missing from the fused driven image. In this case, the fused driven image may be used as the driven target part, and the subsequent operation of S150 continues to be performed.

S150: Generate a target foreground region corresponding to the target object according to the driven target part and a region other than the target part in the foreground region.

After the driven target part is obtained, the foreground region in the composite image may be obtained, the region other than the target part in the foreground region may be obtained, and then the driven target part may be stitched with the region other than the target part in the foreground region, to obtain a stitched result as the target foreground region. The pose of the driven part of the target object in the target foreground region is a pose after the target action is outputted.

Since the target object other than the target part is not changed, the region other than the target part in the foreground region in the composite image may be directly obtained, and the region other than the target part in the foreground region may be directly stitched the driven target part as a target object whose pose of the driven part has changed.

In one embodiment, after S150, the method may include: using a preset background image as a background of the target foreground region and fusing the target foreground region and the preset background image, to obtain a target background-replaced image.

In this embodiment, the preset background image may be any image, and may be a landscape image, a building image, or an animal image. The preset background image may or may not include the target object, and a size of the preset background image is the same as the size of the driven image corresponding to the target object.

Any image may be obtained as the background image, and the background image is adjusted to be the preset background image whose size is the same as the size of the driven image corresponding to the target object.

In this embodiment, the preset background image may be used as the background of the target foreground region, and the target foreground region may be superimposed on the preset background image. The pixel values of the pixel points in the target foreground region are retained in an overlapping part, and the pixel values of the pixel points in the preset background image are retained in a non-overlapping part, to obtain the target background-replaced image.

In this embodiment, the target part in the target region is driven, the target region including the driven target part is determined as the driven image, and the driven target part in the driven image is extracted by using the pixels of the driven image and the pixels of the background region. Since the pose change of the driven part may cause changes in other parts around the driven part, in this application, the target part whose range is larger than a range of the driven part may be determined. Therefore, when some images corresponding to the driven part are processed, images corresponding to other parts except the driven part are also processed, thereby improving the accuracy of segmenting the driven target part. This application avoids reusing the pre-segmentation mask to segment the driven image, preventing the segmented driven target part from including pixel points in the background region and avoiding missing some pixel points of the driven target part, thereby improving the accuracy of the segmented target foreground region, and further improving the effect of the segmentation.

Moreover, directly stitching the region other than the target part in the foreground region with the driven target part does not require processing of all composite images of the target object, but only requiring processing of the driven image corresponding to the target region in which the target part is located, greatly reducing the data processing amount. In addition, the region other than the target part in the foreground region that is determined by using the pre-segmentation mask is reused, thereby further improving efficiency of segmenting the target foreground region.

In addition, the region segmentation mask corresponding to the target region may be obtained from the pre-segmentation mask corresponding to the green screen image. The region segmentation mask is fused with the driven image, to obtain the fused driven image. in response to that the fused driven image meets the preset condition, the fused driven image is directly obtained as the driven target part, so that the driven target part is no longer re-extracted by using the pixels of the driven image and the pixels of the background region, thereby improving the efficiency of extracting the target part, and further improving the efficiency of segmenting the target foreground region.

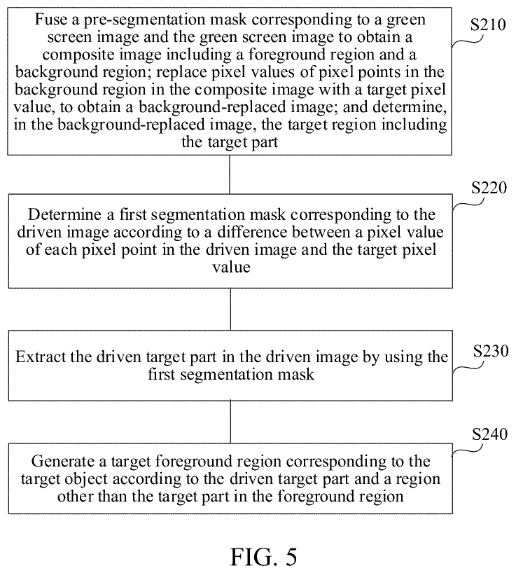

FIG. 5 is a flowchart of an image processing method according to another embodiment of this application. The method may be applied to an electronic device. The electronic device may be the terminal 20 or the server 10 in FIG. 1. The method includes the following operations.

S210: Fuse a pre-segmentation mask corresponding to a green screen image and the green screen image to obtain a composite image including a foreground region and a background region; replace pixel values of pixel points in the background region in the composite image with a target pixel value, obtain a background-replaced image; and determine, in the background-replaced image, the target region including the target part.

For descriptions of S210, refer to the descriptions of S110 to S130, and details are not described herein again.

S220: Determine a first segmentation mask corresponding to the driven image according to a difference between a pixel value of each pixel point in the driven image and the target pixel value.

A mask value respectively corresponding to each pixel point in the driven image may be determined according to the difference between the pixel value of each pixel point in the driven image and the target pixel value; and the first segmentation mask corresponding to the driven image is determined according to the mask value respectively corresponding to each pixel point in the driven image.

For example, a comparison result between the difference between the pixel value of each pixel point in the driven image and the target pixel value and a preset difference may be determined, and the respective mask value of each pixel point in the driven image is determined according to the comparison result. The preset difference may be a value set based on requirements. For example, a difference between a pixel value of a driven pixel point and the target pixel value may be a squared Euclidean distance between the pixel value of the driven pixel point and the target pixel value, and the preset difference may be a threshold for indicating the squared Euclidean distance.

If the difference between the pixel value of the driven pixel point and the target pixel value is the squared Euclidean distance between the pixel value of the driven pixel point and the target pixel value, for a calculation process of the difference between the pixel value of the driven pixel point and the target pixel value, refer to Formula 1. Formula 1 is as follows:

$$D = ( x - p 1 ) \hat{} 2 + ( y - p 2 ) \hat{} 2 + ( z - p 3 ) \hat{} 2 \qquad ( 1 )$$

D refers to a squared Euclidean distance between a pixel value of a driven pixel point and a target pixel value, (x, y, z) refers to an RGB pixel value of the driven pixel point, and (p1, p2, p3) refers to an RGB pixel value of a target pixel point.

For example, the preset difference includes a first threshold and a second threshold, and the first threshold is greater than the second threshold. For each pixel point in the driven image corresponding to the target object, in response to that the difference between the pixel value of the pixel point and the target pixel value is greater than or equal to the first threshold, the mask value of the pixel point is determined as a first value; in response to that the difference between the pixel value of the pixel point and the target pixel value is less than or equal to the second threshold, the mask value of the pixel point is determined as a second value; or in response to that the difference between the pixel value of the pixel point and the target pixel value is not greater than the first threshold and is not less than the second threshold, the mask value of the pixel point may be calculated according to the first value, the second value, and the difference between the pixel value of the pixel point and the target pixel value. The first value is greater than the second value. For example, the first value may be 1, the second value may be 0, the first threshold may be 40, and the second threshold may be 20.

If the difference between the pixel value of the pixel point and the target pixel value is not greater than the first threshold and is not less than the second threshold, the calculating the mask value of the pixel point according to the first value, the second value, and the difference between the pixel value of the pixel point and the target pixel value may include: using a difference between the difference between the pixel value of the pixel point and the target pixel value and the second threshold as a first result, using a difference between the first threshold and the second threshold as a second result, and obtaining a ratio of the first result to the second result as the mask value of the pixel point.

As above, a calculation process of the mask value of the driven pixel point may be expressed as Formula 2. Formula 2 is as follows:

$$\begin{matrix}Alpha = c 1 , D >= Dmax ; \\ Alpha = c 2 , D \text{=<} Dmin ; \\ Alpha = ( D - Dmin ) / ( Dmax - Dmin ) , Dmin < D < Dmin ;\end{matrix} \qquad ( 2 )$$

Alpha is a mask value of a driven pixel point, D is a difference (that is, a squared Euclidean distance) between a pixel value of the driven pixel point and a target pixel value, Dmin is a second threshold, Dmax is a first threshold, c1 is a first value, and c2 is a second value.

S230: Extract the driven target part in the driven image by using the first segmentation mask.

After the first segmentation mask is obtained, the first segmentation mask may be fused with the driven image, to segment the driven image, to obtain a region corresponding to the target part in the target object. The region is the driven target part, and a pose of the target part is a pose for performing the target action.

The first segmentation mask may include the respective mask value of each pixel point in the driven image. In this case, fusing the first segmentation mask with the driven image may refer to multiplying the pixel value of each pixel point in the driven image by the respective corresponding mask value.

In one embodiment, before S230, the method further includes: performing edge inward corrosion processing on edges of the target part in the first segmentation mask, to obtain a second segmentation mask corresponding to the driven image. Correspondingly, S230 includes: extracting the driven target part in the driven image by using the second segmentation mask.

The edges of the target part in the first segmentation mask may be contour lines of the target part in the first segmentation mask. The edge inward corrosion processing may refer to performing smoothing processing on the edges of the target part in the first segmentation mask, so that changes of pixel values on both sides of the edges of the target part in the first segmentation mask are smoother and more continuous.

In some embodiments, the inward corrosion processing may be performed on all edges or some edges of the target part in the first segmentation mask. For example, in a case that the target part is the head, generally, the region of higher user focus is the face. In this case, the inward corrosion processing may be performed on edges of the face in the target part, and the inward corrosion processing does not need to be performed on other edges of the target part other than the edges of the face, thereby saving processing resources and saving time spent on the inward corrosion processing.

The performing edge inward corrosion processing on edges of the target part in the first segmentation mask, to obtain a second segmentation mask corresponding to the driven image includes: performing convolution processing on the edges of the target part in the first segmentation mask by using a convolution kernel of a target size, to obtain a third segmentation mask corresponding to the driven image; and performing smoothing processing on the edges of the target part in the third segmentation mask by using a blur kernel, to obtain the second segmentation mask corresponding to the driven image. The target size may be 3×3, and the blur kernel may be a 5×5 blur kernel.

The second segmentation mask may include the respective mask value of each pixel point in the driven image. The extracting the driven target part in the driven image by using the second segmentation mask may be multiplying the pixel value of each pixel point in the driven image by the respective corresponding mask value, to obtain the driven target part.

S240: Generate a target foreground region corresponding to the target object according to the driven target part and a region other than the target part in the foreground region.

For descriptions of S240, refer to the descriptions of the foregoing S150, and details are not described herein again.

In this embodiment, the first segmentation mask is determined according to the difference between the pixel value of each pixel point in the driven image and the target pixel value, and then the edges of the target part in the first segmentation mask are processed by using the convolution kernel and the blur kernel, to implement smoothing processing on the edges of the target part in the first segmentation mask. This can ensure smooth edges of the target part of the target foreground region obtained through subsequent segmentation based on the first segmentation mask, and can ensure the effect of the target foreground region obtained subsequently, thereby improving the effect of image segmentation.

In addition, in this application, considering that when the driven part of the target object is driven, it may cause another associated part near the driven part to move together, in the foregoing embodiment, the target region in which the target part including the driven part is located is obtained from the background-replaced image, and then action driving is performed based on this target region, instead of obtaining the region in which the driven part is located from the background-replaced image for motion driving, thereby ensuring that the subsequently determined second segmentation mask can accurately express the region in which the driven part obtained after driving is located and the region in which the part that moves together with the driven part after driving is located. Further, the accuracy of subsequent segmentation based on the second segmentation mask is ensured.

In addition, the edges of the target part in the first segmentation mask are processed by using the convolution kernel and the blur kernel, to implement smoothing processing on the edges of the target part in the first segmentation mask. This can ensure smooth edges of the target part of the target foreground region obtained through subsequent segmentation based on the second segmentation mask, and can ensure the effect of the target foreground region obtained subsequently, thereby improving the effect of image segmentation.

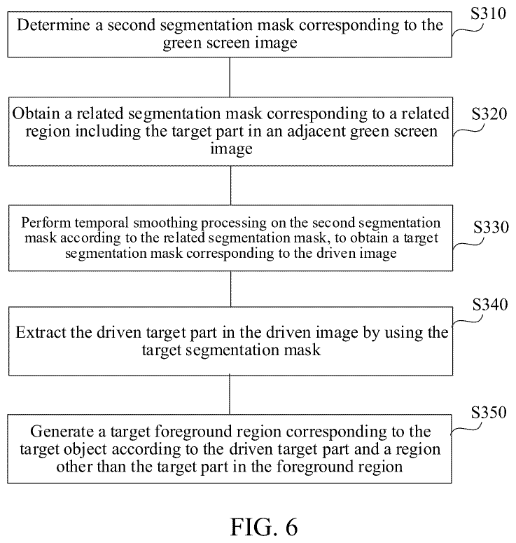

FIG. 6 is a flowchart of an image processing method according to still another embodiment of this application. The method may be applied to an electronic device. The electronic device may be the terminal 20 or the server 10 in FIG. 1. The method includes the following operations.

S310: Determine a second segmentation mask corresponding to the green screen image.

For descriptions of S310, refer to the descriptions of S210 to S230, and details are not described herein again.

S320: Obtain a related segmentation mask corresponding to a related region including the target part in an adjacent green screen image.

The adjacent green screen image is a video frame in a target video that is adjacent to the green screen image and includes the target object; and the related segmentation mask is configured for indicating a region in which the target part is located after a driven part in the related region is driven.

A video frame that needs to be adjusted may be determined in the target video as the green screen image, and a video frame in the target video that is adjacent to the green screen image and preceding the green screen image and that includes the target object, or a video frame in the target video that is adjacent to the green screen image and subsequent to the green screen image and that includes the target object is used as the adjacent green screen image. The video frame that needs to be adjusted is a video frame in which the target part of the target object in the video frame needs to be driven.

The related region may refer to a region in the adjacent green screen image that includes the target part. For example, in response to that the adjacent green screen image is a video frame including a person, and the target part is the head of the person, the related region refers to a region in the adjacent green screen image in which the head of the person is located.

The related segmentation mask may refer to the segmentation mask for segmenting the target part in the related region after the driven part in the related region is driven, and the related segmentation mask may be a mask image having the same size as the related region. The related segmentation mask may include a mask value corresponding to each pixel point in the related region.

In one embodiment, S320 may include: fusing a pre-segmentation mask corresponding to the adjacent green screen image and the adjacent green screen image, to obtain a related composite image including a related foreground region and a related background region, the related foreground region having the target object; replacing pixel values of pixel points in the related background region in the related composite image with the target pixel value, to obtain a related background-replaced image; determining, in the related background-replaced image, a related target region including the target part; driving the target part in the related target region, to obtain a related driven image; and determining the related segmentation mask corresponding to the related target region according to pixels of the related driven image and the target pixel value.

A region in the adjacent green screen image that includes the target object is used as the related foreground region and a region excluding the target object is used as the related background region. A pre-segmentation mask of the adjacent green screen image may be determined by using the segmentation model, and then the adjacent green screen image and the pre-segmentation mask corresponding to the adjacent green screen image are fused, to obtain the related composite image. The pixel values of the pixel points in the related background region other than the related foreground region in which the target object is located in the related composite image are replaced with the target pixel value, to obtain the related background-replaced image.

The related target region may refer to a region in the related background-replaced image that includes the target part. For example, in response to that the related background-replaced image is an image including a person, and the target part is the head of the person, the related target region refers to a region in the related background-replaced image in which the head of the person is located.

In some implementations, the target part in the related target region may be driven according to a related action, a pose of the driven part of the target object in the related target region changes to a pose corresponding to performing the related action, and when the pose of the driven part changes to the pose corresponding to performing the related action, an image of the target part is used as the related driven image. That is, the related driven image refers to the related target region when the driven part performs the related action.

The related action refers to an action for driving the driven part of the target object in the related target region, and has the same meaning as the target action, and details are not described herein again. For example, when the driven part is the face (including the mouth) of a person, the related action may be an action of the person saying “ni”.

For example, the target object in the related target region is a person, the driven part is the face (including the mouth), a pose of the face of the person in the related target region is an image when the person says “wo”, and the related action is an action for saying the word “men”. The face of the person in the related target region is driven according to the related action, to obtain the image when the person says “men” as the related driven image.

The mask value of each pixel point in the related driven image may be determined according to a difference between the pixel value of each pixel point in the related driven image corresponding to the target object and the target pixel value, and the mask values of all pixel points in the related driven image are aggregated, to obtain the related segmentation mask.

The related driven image is determined based on the related target region. Therefore, the related driven image and the related target region are the same size. The related region is a region in the adjacent green screen image that includes the target part. The related target region is a region in the related background-replaced image that includes the target part. However, the difference between the related background-replaced image and the adjacent green screen image lies in the pixel values of the pixel points in the background. Therefore, the related target region and the related region also have the same size, and the difference between the related target region and the related region lies in the pixel values of the pixel points in the background. Therefore, after the driven part in the related region is driven, the target part obtained after the driven part in the related region is driven can also be segmented by using the relevant segmentation mask.

In one embodiment, a comparison result between the difference between the pixel value of each pixel point in the related driven image and the target pixel value and a preset difference may be determined, and the respective mask value of each pixel point in the related driven image is determined according to the comparison result. The difference between the pixel value of each pixel point in the related driven image corresponding to the target object and the target pixel value may be a Euclidean distance, a cosine similarity, or the like between the pixel value of each pixel point in the related driven image corresponding to the target object and the target pixel value.

For example, the preset difference includes a first threshold and a second threshold, and the first threshold is greater than the second threshold. For each pixel point in the related driven image, in response to that the difference between the pixel value of the pixel point and the target pixel value is greater than or equal to the first threshold, the mask value of the pixel point is determined as a first value; in response to that the difference between the pixel value of the pixel point and the target pixel value is less than or equal to the second threshold, the mask value of the pixel point is determined as a second value; or in response to that the difference between the pixel value of the pixel point and the target pixel value is not greater than the first threshold and is not less than the second threshold, the mask value of the pixel point may be calculated according to the first value, the second value, and the difference between the pixel value of the pixel point and the target pixel value.

If the difference between the pixel value of the pixel point and the target pixel value is not greater than the first threshold and is not less than the second threshold, the calculating the mask value of the pixel point according to the first value, the second value, and the difference between the pixel value of the pixel point and the target pixel value may include: using a difference between the difference between the pixel value of the pixel point and the target pixel value and the second threshold as a third result, using a difference between the first threshold and the second threshold as a second result, obtaining a ratio of the third result to the second result as the mask value of the pixel point.

In one embodiment, a comparison result between the difference between the pixel value of each pixel point in the related driven image and the target pixel value and the preset difference may be further determined, the mask value of each pixel point in the related driven image is determined according to the comparison result, the mask values of all pixel points in the related driven image are aggregated, to obtain a related region mask, and edge inward corrosion processing is performed on edges of a target part in the related region mask, to obtain the related segmentation mask.

The edges of the target part in the related region mask may be contour lines of the target part in the related region mask. The edge inward corrosion processing may refer to performing smoothing processing on the edges of the target part in the related region mask, so that changes of pixel values on both sides of the edges of the target part in the related region mask are smoother and more continuous.

In some embodiments, the inward corrosion processing may be performed on all edges or some edges of the target part in the related region mask. For example, in a case that the target part is the head, generally, the region of higher user focus is the face. In this case, the inward corrosion processing may be performed on edges of the face in the target part, and the inward corrosion processing does not need to be performed on other edges of the target part other than the edges of the face, thereby saving processing resources and saving time spent on the inward corrosion processing.

The performing edge inward corrosion processing on edges of the target part in the related region, to obtain a related segmentation mask corresponding to the driven image includes: performing convolution processing on the edges of the target part in the related region mask by using a convolution kernel of a target size, to obtain a pre-processed mask; and performing smoothing processing on the edges of the target part in the pre-processed mask by using a blur kernel, to obtain the related segmentation mask. The target size may be 3×3, and the blur kernel may be a 5×5 blur kernel.

S330: Perform temporal smoothing processing on the second segmentation mask according to the related segmentation mask, to obtain a target segmentation mask corresponding to the driven image.

Temporal smoothing processing is performed on the second segmentation mask by using the related segmentation mask, to avoid excessive jitter in the target foreground region segmented according to the second segmentation mask between time sequences of the target video, so that the segmentation result of the adjacent green screen image and the segmentation result of the green screen image provide a smoother and more continuous mask for the target part of the target object.

The adjacent green screen image includes a first adjacent green screen image preceding the green screen image and a second adjacent green screen image subsequent to the green screen image in the target video, and the related segmentation mask includes a first related segmentation mask corresponding to the first adjacent green screen image and a second related segmentation mask corresponding to the second adjacent green screen image. S330 may include: performing weighted summation on the first related segmentation mask, the second related segmentation mask, and the second segmentation mask, to obtain the target segmentation mask. Weights of the first related segmentation mask, the second related segmentation mask, and the second segmentation mask may be set based on requirements, and the second segmentation mask has the greatest weight.

For example, the weight of the first related segmentation mask is 0.1, the weight of the second related segmentation mask is 0.1, and the weight of the second segmentation mask is 0.8. In this case, a process of determining the target segmentation mask of the green screen image is: A21=0.1*A1+0.8*A2+A3*0.1, where A21 is a second segmentation mask of a green screen image, A1 is a first related segmentation mask, A3 is a second related segmentation mask, and A1 is a second segmentation mask.

S340: Extract the driven target part in the driven image by using the target segmentation mask.

After the target segmentation mask is obtained, the target segmentation mask may be fused with the driven image, to segment the driven image, to obtain the driven target part. The pose of the driven part in the driven target part is a pose for outputting the target action.

The target segmentation mask includes the respective mask value of each pixel point in the driven image. In this case, fusing the target segmentation mask with the driven image may refer to multiplying the pixel value of each pixel point in the driven image by the respective corresponding mask value.

S350: Generate a target foreground region corresponding to the target object according to the driven target part and a region other than the target part in the foreground region.

For descriptions of S350, refer to the descriptions of the foregoing S150, and details are not described herein again.

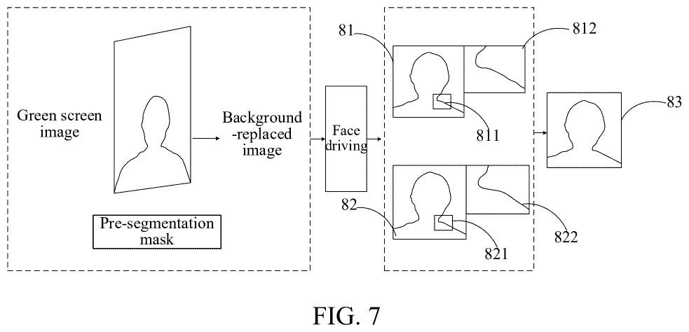

Referring to FIG. 7, the green screen image and the pre-segmentation mask corresponding to the green screen image are fused to obtain the composite image, and then the pixel values of the pixel points of the background region in the composite image are replaced with the target pixel value, to obtain the background-replaced image. Since the green screen image is an image only including the target part (head), the background-replaced image may be directly determined as the target region including the target part.

Then, face driving is performed on the target region, to obtain a corresponding driven image, and an initial segmentation mask 81 is determined according to the difference between the pixel value of each pixel point in the driven image and the target pixel value of the pixel point in the background in the background-replaced image. As shown in an enlarged image 812 of an edge local region 811 of the initial segmentation mask 81, edges of the initial segmentation mask 81 are not sufficiently smooth and continuous. Edge inward and temporal smoothing processing continues to be performed on the initial segmentation mask 81, to obtain a target segmentation mask 82. A result obtained after an edge local region 821 of the target segmentation mask 82 is enlarged is 822, and edges of the target segmentation mask 82 are smooth and continuous.

The driven image is segmented by using the target segmentation mask 82, to obtain a driven target part 83. Since the background-replaced image corresponding to the composite image is used as the target region, and the foreground region of the composite image no longer includes a region other than the target part (head), the driven target part 83 may be used as the target foreground region.

In this embodiment, when the green screen image in the target video is processed, temporal smoothing processing is performed on the second segmentation mask of the green screen image according to the related segmentation mask corresponding to the adjacent green screen image, resulting in higher accuracy for the obtained target segmentation mask, thereby improving the accuracy of the driven target part extracted according to the target segmentation mask, and further improving the effect of determining the target foreground region.

To explain the technical solutions of this application more clearly, the following explains the image processing method of this application with reference to an exemplary scenario. In this scenario, a target video is a two-minute video, the target video is a video of a digital intelligent human talking, talking content is A, the talking content of the target video needs to be adjusted to B, and an adjusted video is used as a live video for live streaming.

Any video frame P2 in the target video is determined as a target video frame, and a previous video frame P1 and a next video frame P3 of P2 are obtained, where a related action of P1 is saying “ni”, a target action of P2 is saying “men”, and a related action of P3 is saying “hao”, a driven part is the face (including the mouth), and a target part is the head. The target object may be the digital intelligent human.

A process of obtaining a segmentation mask related to P1:

P1 is processed by using a deep learning-based segmentation mask, to obtain a pre-segmentation mask P12 corresponding to P1, P1 and P12 are fused, to obtain a related composite image P13, pixel values of a background region other than the person in P13 are adjusted to a target pixel value RGB (0, 124, 0), to obtain a related background-replaced image P14, a related target region P15 corresponding to a head region is determined in P14, the face in P15 is driven according to an action for saying “ni”, to obtain a related driven image P16 corresponding to the head, a mask value of each pixel point in P16 is determined according to a difference between a pixel value of each pixel point in P16 and a target pixel value according to Formula 1 and Formula 2, and then the mask values of all pixel points in P16 are aggregated, to obtain a related region mask P17 corresponding to P15.

Then, convolution processing may be performed on edges of the head in P17 by using a convolution kernel of a target size, to obtain a pre-processing mask P18 corresponding to P17. Smoothing processing is performed on the edges of the head in P18 by using a blur kernel, to obtain a related segmentation mask of P1.

A process of obtaining the second segmentation mask of P2:

P2 is processed by using the deep learning-based segmentation mask, to obtain a pre-segmentation mask P22 corresponding to P2, P2 and P22 are fused, to obtain a composite image P23, pixel values of a background region other than the person in P23 are adjusted to the target pixel value RGB (0, 124, 0), to obtain a background-replaced image P24, a target region P25 corresponding to the head is determined in P24, the face in P25 is driven according to an action for saying “men”, to implement face driving, to obtain a driven image P26 corresponding to the head, a mask value of each pixel point in P26 is determined according to a difference between a pixel value of each pixel point in P26 and the target pixel value according to Formula 1 and Formula 2, and then the mask values of all pixel points in P26 are aggregated, to obtain a first segmentation mask P27.

Then, convolution processing may be performed on edges of the head in P27 by using the convolution kernel of the target size, to obtain a third segmentation mask P28. Smoothing processing is performed on the edges of the head in P28 by using the blur kernel, to obtain a second segmentation mask of P2.

A process of obtaining a segmentation mask related to P3:

P3 is processed by using a deep learning-based segmentation mask, to obtain a pre-segmentation mask P32 corresponding to P3, P3 and P32 are fused, to obtain a related composite image P33, pixel values of a background region other than the person in P33 are adjusted to a target pixel value RGB (0, 124, 0), to obtain a related background-replaced image P34, a related target region P35 corresponding to a head region is determined in P34, the face in P35 is driven according to an action for saying “hao”, to obtain a related driven image P36 corresponding to the head, a mask value of each pixel point in P36 is determined according to a difference between a pixel value of each pixel point in P36 and a target pixel value according to Formula 1 and Formula 2, and then the mask values of all pixel points in P36 are aggregated, to obtain a related region mask P37 corresponding to the related target region P35.

Then, convolution processing may be performed on edges of the head in P37 by using the convolution kernel of the target size, to obtain a pre-processing mask P38 corresponding to P37. Smoothing processing is performed on the edges of the head in P38 by using the blur kernel, to obtain a related segmentation mask of P3.

In this way, the related segmentation mask of P1, the second segmentation mask of P2, and the related segmentation mask of P3 are determined. Weighted summation is performed on the related segmentation mask of P1, the second segmentation mask of P2, and the related segmentation mask of P3 according to the weight 0.1 of the related segmentation mask of P1, the weight 0.8 of the second segmentation mask of P2, and the weight 0.1 of the related segmentation mask of P3, to obtain a summation result. The summation result is a target segmentation mask P0.

The driven image P26 is segmented by using the target segmentation mask P0, to obtain a driven head P29, a region P210 other than the head is determined in the foreground region of the composite image, and P29 and P210 are stitched into a target object, to obtain a target foreground region.

Then, a preset background image is obtained, the preset background image is used as a background of the target foreground region, and the target foreground region is superimposed on the preset background image to obtain a target background-replaced image corresponding to P2. After the target background-replaced image corresponding to P2 is obtained, the target background-replaced image may be played in a live streaming manner, to implement live streaming of the digital intelligent human.

In this scenario, a fast post-driving segmentation solution applicable to a live streaming scenario of the digital intelligent human is provided, which facilitates an efficient live streaming scenario of the digital intelligent human without the need for manual parameter adjustment. In addition, the patent makes reasonable use of a pre-segmentation result, and only changes the segmentation mask (alpha) of the head region, to finally obtain a refined matting effect. In terms of time consumption, it only requires 3 ms per image, meeting live streaming requirements.

In addition, it overcomes the defect that the previously reused segmentation mask becomes inaccurate due to changes in cheek size caused by driving the mouth shape, thereby improving the live streaming effect of the digital intelligent human. Post-driving segmentation is performed on the driven head, to optimize segmentation time of a central processing unit (CPU) to 3 milliseconds per image, leaving sufficient time for action driving.

The post-driving segmentation algorithm uses color gamut information for edge erosion and sequence smoothing, to obtain a refined and temporally stable matting effect, thereby correcting the problem of facial edge exposure after driving caused by reusing an original segmentation image.

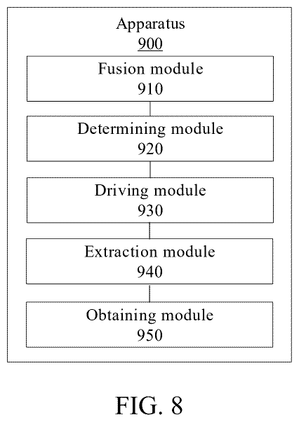

FIG. 8 is a block diagram of an image processing apparatus according to an embodiment of this application. The apparatus 900 includes:
a fusion module 910, configured to fuse a pre-segmentation mask corresponding to a green screen image and the green screen image to obtain a composite image including a foreground region and a background region, the foreground region having a target object, and the target object including a target part;
a determining module 920, configured to determine, in the composite image, a target region including a target part;
a driving module 930, configured to drive the target part in the target region, to determine a target region including the driven target part as a driven image;
an extraction module 940, configured to extract the driven target part in the driven image according to pixels of the driven image and pixels of the background region; and
an obtaining module 950, configured to generate a target foreground region corresponding to the target object according to the driven target part and a region other than the target part in the foreground region.

In some embodiments, the determining module 920 is further configured to replace pixel values of pixel points in the background region in the composite image with a target pixel value, to obtain a background-replaced image; and determine, in the background-replaced image, the target region including the target part. Correspondingly, the extraction module 940 is further configured to extract the driven target part in the driven image according to pixel values of pixel points of the driven image and the target pixel value.

In some embodiments, the extraction module 940 is further configured to determine a first segmentation mask corresponding to the driven image according to a difference between a pixel value of each pixel point in the driven image and the target pixel value; and extract the driven target part in the driven image by using the first segmentation mask.

In some embodiments, the extraction module 940 is further configured to determine a mask value respectively corresponding to each pixel point in the driven image according to the difference between the pixel value of each pixel point in the driven image and the target pixel value; and determine the first segmentation mask corresponding to the driven image according to the mask value respectively corresponding to each pixel point in the driven image.

In some embodiments, the extraction module 940 is further configured to determine, in response to that a difference between a pixel value of a driven pixel point and the target pixel value is greater than or equal to a first threshold, a mask value of the driven pixel point as a first value, the driven pixel point being any pixel point in the driven image; determine, in response to that the difference between the pixel value of the driven pixel point and the target pixel value is less than or equal to a second threshold, the mask value of the driven pixel point as a second value, the first value being greater than the second value; or determine, in response to that the difference between the pixel value of the driven pixel point and the target pixel value is not greater than the first threshold and the difference between the pixel value of the driven pixel point and the target pixel value is not less than the second threshold, the mask value of the driven pixel point according to the difference between the pixel value of the driven pixel point and the target pixel value, the first threshold, and the second threshold.

In some embodiments, the extraction module 940 is further configured to perform edge inward corrosion processing on edges of the target part in the first segmentation mask, to obtain a second segmentation mask corresponding to the driven image; and extract the driven target part in the driven image by using the second segmentation mask.

In some embodiments, the extraction module 940 is further configured to perform convolution processing on the edges of the target part in the first segmentation mask by using a convolution kernel of a target size, to obtain a third segmentation mask corresponding to the driven image; and perform smoothing processing on the edges of the target part in the third segmentation mask by using a blur kernel, to obtain the second segmentation mask corresponding to the driven image.

In some embodiments, the green screen image is a video frame included in a target video; and the extraction module 940 is further configured to obtain a related segmentation mask corresponding to a related region including the target part in an adjacent green screen image, the adjacent green screen image being a video frame in the target video that is adjacent to the green screen image and includes the target object, and the related segmentation mask being configured to indicate a region in which the target part is located after a driven part in the related region is driven; perform temporal smoothing processing on the second segmentation mask according to the related segmentation mask, to obtain a target segmentation mask corresponding to the driven image; and extract the driven target part in the driven image by using the target segmentation mask.

In some embodiments, the extraction module 940 is further configured to fuse a pre-segmentation mask corresponding to the adjacent green screen image and the adjacent green screen image, to obtain a related composite image including a related foreground region and a related background region, the related foreground region having the target object; replace pixel values of pixel points in the related background region in the related composite image with the target pixel value, to obtain a related background-replaced image; determine, in the related background-replaced image, a related target region including the target part; drive the target part in the related target region, to obtain a related driven image; and determine the related segmentation mask corresponding to the related target region according to pixels of the related driven image and the target pixel value.

In some embodiments, the adjacent green screen image includes a first adjacent green screen image preceding the green screen image and a second adjacent green screen image subsequent to the green screen image in the target video, and the related segmentation mask includes a first related segmentation mask corresponding to the first adjacent green screen image and a second related segmentation mask corresponding to the second adjacent green screen image; and the extraction module 940 is further configured to perform weighted summation on the first related segmentation mask, the second related segmentation mask, and the second segmentation mask, to obtain the target segmentation mask.

In some embodiments, the obtaining module 950 is further configured to use a preset background image as a background of the target foreground region and fuse the target foreground region and the preset background image, to obtain a target background-replaced image.

In some embodiments, the extraction module 940 is further configured to obtain a region segmentation mask corresponding to the target region from the pre-segmentation mask corresponding to the green screen image; fuse the region segmentation mask with the driven image, to obtain a fused driven image; and extract, in response to that the fused driven image does not meet a preset condition, the driven target part in the driven image according to the pixels of the driven image and the pixels of the background region.

The apparatus embodiments and the foregoing method embodiments in this application mutually correspond. For specific principles in the apparatus embodiments, reference may be made to the content in the foregoing method embodiments, and details are not described herein again.

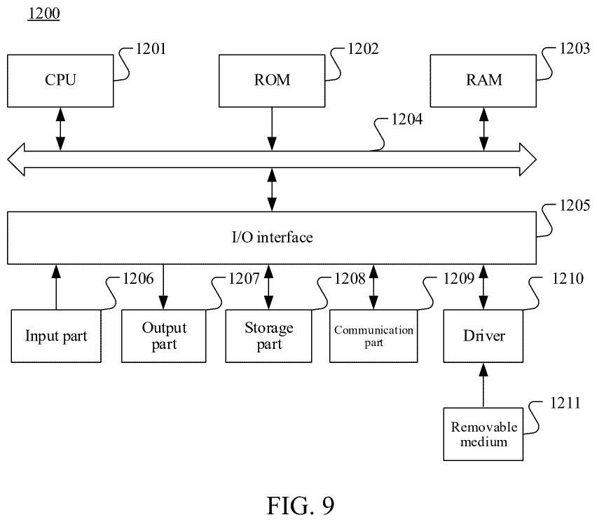

FIG. 9 is a structural block diagram of an electronic device configured to perform the image processing method according to the embodiments of this application. The electronic device may be the terminal 20, the server 10, or the like in FIG. 1. A computer system 1200 of the electronic device shown in FIG. 9 is merely an example, and will not impose any limitation on the function and scope of the embodiments of this application.

As shown in FIG. 9, the computer system 1200 includes a central processing unit (CPU) 1201, which may perform various suitable actions and processing according to a program stored in a read-only memory (ROM) 1202 or a program loaded from a storage part 1208 to a random access memory (RAM) 1203, for example, perform the methods in the foregoing embodiments. The RAM 1203 further stores various programs and data required by system operations. The CPU 1201, the ROM 1202, and the RAM 1203 are connected to each other by using a bus 1204. An input/output (I/O) interface 1205 is also connected to the bus 1204.

The following components are connected to the I/O interface 1205: an input part 1206 including a keyboard, a mouse, and the like; an output part 1207 including, for example, a cathode ray tube (CRT), a liquid crystal display (LCD), and a speaker; a storage part 1208 including a hard disk and the like; and a communication part 1209 including a network interface card such as a local area network (LAN) card or a modem. The communication part 1209 performs communication processing by using a network such as the Internet. A driver 1210 is also connected to the I/O interface 1205 as required. A removable medium 1211, such as a magnetic disk, an optical disk, a magneto-optical disk, a semiconductor memory, and the like are installed on the driver 1210 as needed, so that it may be read that a computer program is installed to the storage part 1208 as required.

Particularly, according to an embodiment of this application, the foregoing processes described with reference to the flowcharts may be implemented as a computer software program. For example, an embodiment of this application includes a computer program product, including a computer program carried in a computer-readable medium, the computer program including program code used for performing the methods shown in the flowcharts. In such an embodiment, the computer program may be downloaded and installed through the communication part 1209 from a network, and/or installed from the removable medium 1211. When the computer program is executed by the CPU 1201, various functions defined in the system of this application are performed.

The computer-readable medium shown in the embodiments of this application may be a computer-readable signal medium, a computer-readable storage medium, or any combination thereof. The computer-readable storage medium may be, for example, but is not limited to, an electrical, magnetic, optical, electromagnetic, infrared, or a semiconductor system, apparatus or component, or any combination thereof. A more specific example of the computer-readable storage medium may include but is not limited to an electrical connection having one or more wires, a portable computer magnetic disk, a hard disk, a RAM, a ROM, an erasable programmable read-only memory (EPROM), a flash memory, an optical fiber, a compact disc read-only memory (CD-ROM), an optical storage device, a magnetic storage device, or any appropriate combination thereof. In this application, the computer-readable storage medium may be any tangible medium containing or storing a program, and the program may be used by or used in combination with an instruction execution system, an apparatus, or a device. In this application, the computer-readable signal medium may include a data signal being in a baseband or propagated as a part of a carrier wave, which carries computer-readable program code. The propagated data signal may have various forms, including but not limited to an electromagnetic signal, an optical signal, or any proper combination thereof. The computer-readable signal medium may be further any computer-readable medium in addition to a computer-readable storage medium. The computer-readable medium may send, propagate, or transmit a program that is used by or used in combination with an instruction execution system, apparatus, or device. The program code included in the computer-readable medium may be transmitted by using any appropriate medium, including but not limited to: a wireless medium, a wired medium, and the like, or any suitable combination thereof.

Flowcharts and block diagrams in the drawings illustrate architectures, functions, and operations that may be implemented using the system, the method, and the computer program product according to various embodiments of this application. Each block in the flowchart or the block diagram may represent a module, a program segment, or a part of code. The module, the program segment, or the part of the code include one or more executable instructions for implementing specific logical functions. In some alternative implementations, functions annotated in the blocks may also be executed in a different order from those annotated in the accompanying drawings. For example, depending on functions involved, two blocks shown in succession may actually be executed substantially in parallel, or may sometimes be executed in reverse order. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The involved unit described in the embodiments of this application may be implemented by software or hardware, and the described unit may also be arranged in a processor. Names of the units do not constitute a limitation on the units in a specific case.

As another aspect, this application further provides a computer-readable storage medium. The computer-readable storage medium may be included in the electronic device described in the foregoing embodiments. Alternatively, the computer-readable storage medium may exist alone and is not assembled into the electronic device. The computer-readable storage medium carries computer-readable instructions, and when the computer-readable instructions are executed by a processor, the method in any one of the foregoing embodiments is implemented.

According to an aspect of the embodiments of this application, a computer program product is provided, the computer program product including computer instructions, the computer instructions being stored in a computer-readable storage medium. A processor of an electronic device reads the computer instructions from the computer-readable storage medium, and the processor executes the computer instructions, to cause the electronic device to perform the method in any one of the foregoing embodiments.

Although a plurality of modules or units of a device configured to perform actions are mentioned in the above detailed description, such division is not mandatory. According to implementations of this application, features and functions of two or more modules or units described above may be specifically implemented in one module or unit. Conversely, the features and functions of one module or unit described above may be further divided into a plurality of modules or units to be embodied.

Based on the descriptions of the foregoing implementations, a person skilled in the art can easily understand that the examples of implementations described herein may be implemented by software, or may be implemented by combining software with necessary hardware. Therefore, the technical solution according to the implementations of this application may be implemented in a form of a software product. The software product may be stored in a non-volatile storage medium (which may be a CD-ROM, a USB flash drive, a removable hard disk, or the like) or on a network, and includes several instructions for instructing an electronic device (which may be a personal computer, a server, a touch terminal, a network device, or the like) to perform the method according to the implementations of this application.

After considering the specification and practicing the implementations of this application, a person skilled in the art may easily conceive of other implementations of this application. This application is intended to cover any variations, uses, or adaptive changes of this application. These variations, uses, or adaptive changes follow the general principles of this application and include common general knowledge or common technical means in the art, which are not disclosed in this application. This application is not limited to the precise structures described above and shown in the accompanying drawings, and various modifications and changes can be made without departing from the scope of this application. The scope of this application is limited by the appended claims only.

At last, the foregoing embodiments are merely used for describing the technical solutions of this application, and are not intended to limit this application. Although this application is described in detail with reference to the above embodiments, a person skilled in the art understands that, modifications may be made to the technical solutions described in the above embodiments, or equivalent replacements may be made to part of the technical features. However, these modifications or replacements do not make the essence of the corresponding technical solutions depart from the spirit and scope of the technical solutions of the embodiments of the present disclosure.

What is claimed is:

1. An image processing method, performed by an electronic device, the method comprising:
fusing a pre-segmentation mask corresponding to a green screen image and the green screen image to obtain a composite image comprising a foreground region and a background region, the foreground region having a target object, and the target object comprising a target part;
determining a target region comprising the target part in the composite image;
driving the target part in the target region;
determining a target region comprising the driven target part as a driven image;
extracting the driven target part in the driven image according to pixels of the driven image and pixels of the background region; and
generating a target foreground region corresponding to the target object according to the driven target part and a region other than the target part in the foreground region.

2. The method according to claim 1, wherein before the determining a target region comprising the target part in the composite image, the method further comprises:
replacing pixel values of pixel points in the background region in the composite image with a target pixel value to obtain a background-replaced image;
the determining a target region comprising the target part in the composite image comprises:
determining the target region comprising the target part in the background-replaced image; and
the extracting the driven target part in the driven image according to pixels of the driven image and pixels of the background region comprises:
extracting the driven target part in the driven image according to pixel values of pixel points of the driven image and the target pixel value.

3. The method according to claim 1, wherein the extracting the driven target part in the driven image according to pixel values of pixel points of the driven image and the target pixel value comprises:
determining a first segmentation mask corresponding to the driven image according to a difference between a pixel value of each pixel point in the driven image and the target pixel value; and
extracting the driven target part in the driven image by using the first segmentation mask.

4. The method according to claim 1, wherein the determining a first segmentation mask corresponding to the driven image according to a difference between a pixel value of each pixel point in the driven image and the target pixel value comprises:
determining a mask value respectively corresponding to each pixel point in the driven image according to the difference between the pixel value of each pixel point in the driven image and the target pixel value; and
determining the first segmentation mask corresponding to the driven image according to the mask value respectively corresponding to each pixel point in the driven image.

5. The method according to claim 1, wherein the determining a mask value respectively corresponding to each pixel point in the driven image according to the difference between the pixel value of each pixel point in the driven image and the target pixel value comprises:
determining a mask value of the driven pixel point as a first value, the driven pixel point being any pixel point in the driven image in response to that a difference between a pixel value of a driven pixel point and the target pixel value is greater than or equal to a first threshold;
determining the mask value of the driven pixel point as a second value, the first value being greater than the second value in response to that the difference between the pixel value of the driven pixel point and the target pixel value is less than or equal to a second threshold; or
determining the mask value of the driven pixel point according to the difference between the pixel value of the driven pixel point and the target pixel value, the first threshold, and the second threshold, in response to that the difference between the pixel value of the driven pixel point and the target pixel value is not greater than the first threshold and the difference between the pixel value of the driven pixel point and the target pixel value is not less than the second threshold.

6. The method according to claim 1, wherein before the extracting the driven target part in the driven image by using the first segmentation mask, the method further comprises:
performing edge inward corrosion processing on edges of the target part in the first segmentation mask, to obtain a second segmentation mask corresponding to the driven image; and
the extracting the driven target part in the driven image by using the first segmentation mask comprises:
extracting the driven target part in the driven image by using the second segmentation mask.

7. The method according to claim 1, wherein the performing edge inward corrosion processing on edges of the target part in the first segmentation mask, to obtain a second segmentation mask corresponding to the driven image comprises:
performing convolution processing on the edges of the target part in the first segmentation mask by using a convolution kernel of a target size, to obtain a third segmentation mask corresponding to the driven image; and
performing smoothing processing on the edges of the target part in the third segmentation mask by using a blur kernel, to obtain the second segmentation mask corresponding to the driven image.

8. The method according to claim 1, wherein the green screen image is a video frame comprised in a target video; and before the extracting the driven target part in the driven image by using the second segmentation mask, the method further comprises:
obtaining a related segmentation mask corresponding to a related region comprising the target part in an adjacent green screen image, the adjacent green screen image being a video frame in the target video that is adjacent to the green screen image and comprises the target object, and the related segmentation mask being configured to indicate a region in which the target part is located after a driven part in the related region is driven; and
performing temporal smoothing processing on the second segmentation mask according to the related segmentation mask, to obtain a target segmentation mask corresponding to the driven image; and
the extracting the driven target part in the driven image by using the second segmentation mask comprises:
extracting the driven target part in the driven image by using the target segmentation mask.

9. The method according to claim 1, wherein the obtaining a related segmentation mask corresponding to a related target region comprising the target part in an adjacent green screen image comprises:
fusing a pre-segmentation mask corresponding to the adjacent green screen image and the adjacent green screen image, to obtain a related composite image comprising a related foreground region and a related background region, the related foreground region having the target object;
replacing pixel values of pixel points in the related background region in the related composite image with the target pixel value, to obtain a related background-replaced image;
determining a related target region comprising the target part in the related background-replaced image;
driving the target part in the related target region, to obtain a related driven image; and
determining the related segmentation mask corresponding to the related target region according to pixels of the related driven image and the target pixel value.

10. The method according to claim 1, wherein the adjacent green screen image comprises a first adjacent green screen image preceding the green screen image and a second adjacent green screen image subsequent to the green screen image in the target video, and the related segmentation mask comprises a first related segmentation mask corresponding to the first adjacent green screen image and a second related segmentation mask corresponding to the second adjacent green screen image; and
the performing temporal smoothing processing on the second segmentation mask according to the related segmentation mask, to obtain a target segmentation mask corresponding to the driven image comprises:
performing weighted summation on the first related segmentation mask, the second related segmentation mask, and the second segmentation mask, to obtain the target segmentation mask.

11. The method according to claim 1, wherein after the generating a target foreground region corresponding to the target object according to the driven target part and a region other than the target part in the foreground region, the method further comprises:
using a preset background image as a background of the target foreground region and fusing the target foreground region and the preset background image, to obtain a target background-replaced image.

12. The method according to claim 1, wherein before the extracting the driven target part in the driven image according to pixels of the driven image and pixels of the background region, the method further comprises:
obtaining a region segmentation mask corresponding to the target region from the pre-segmentation mask corresponding to the green screen image; and
fusing the region segmentation mask with the driven image, to obtain a fused driven image; and
the extracting the driven target part in the driven image according to pixels of the driven image and pixels of the background region comprises:
extracting the driven target part in the driven image according to the pixels of the driven image and the pixels of the background region in response to that the fused driven image does not meet a preset condition.

13. An electronic device, comprising:
one or more processors;
a memory; and
one or more application programs, the one or more application programs being stored in the memory and configured to be executed by the one or more processors, and the one or more application programs being configured to perform an image processing method, performed by an electronic device, the method comprising:
fusing a pre-segmentation mask corresponding to a green screen image and the green screen image to obtain a composite image comprising a foreground region and a background region, the foreground region having a target object, and the target object comprising a target part;
determining a target region comprising the target part in the composite image;
driving the target part in the target region;
determining a target region comprising the driven target part as a driven image;
extracting the driven target part in the driven image according to pixels of the driven image and pixels of the background region; and
generating a target foreground region corresponding to the target object according to the driven target part and a region other than the target part in the foreground region.

14. The electronic device according to claim 13, wherein before the determining a target region comprising the target part in the composite image, the method further comprises:
replacing pixel values of pixel points in the background region in the composite image with a target pixel value to obtain a background-replaced image;
the determining a target region comprising the target part in the composite image comprises:
determining the target region comprising the target part in the background-replaced image; and
the extracting the driven target part in the driven image according to pixels of the driven image and pixels of the background region comprises:
extracting the driven target part in the driven image according to pixel values of pixel points of the driven image and the target pixel value.

15. The electronic device according to claim 13, wherein the extracting the driven target part in the driven image according to pixel values of pixel points of the driven image and the target pixel value comprises:
determining a first segmentation mask corresponding to the driven image according to a difference between a pixel value of each pixel point in the driven image and the target pixel value; and
extracting the driven target part in the driven image by using the first segmentation mask.

16. The electronic device according to claim 13, wherein the determining a first segmentation mask corresponding to the driven image according to a difference between a pixel value of each pixel point in the driven image and the target pixel value comprises:
determining a mask value respectively corresponding to each pixel point in the driven image according to the difference between the pixel value of each pixel point in the driven image and the target pixel value; and
determining the first segmentation mask corresponding to the driven image according to the mask value respectively corresponding to each pixel point in the driven image.

17. The electronic device according to claim 13, wherein the determining a mask value respectively corresponding to each pixel point in the driven image according to the difference between the pixel value of each pixel point in the driven image and the target pixel value comprises:
determining a mask value of the driven pixel point as a first value, the driven pixel point being any pixel point in the driven image in response to that a difference between a pixel value of a driven pixel point and the target pixel value is greater than or equal to a first threshold;
determining the mask value of the driven pixel point as a second value, the first value being greater than the second value in response to that the difference between the pixel value of the driven pixel point and the target pixel value is less than or equal to a second threshold; or
determining the mask value of the driven pixel point according to the difference between the pixel value of the driven pixel point and the target pixel value, the first threshold, and the second threshold, in response to that the difference between the pixel value of the driven pixel point and the target pixel value is not greater than the first threshold and the difference between the pixel value of the driven pixel point and the target pixel value is not less than the second threshold.

18. The electronic device according to claim 13, wherein before the extracting the driven target part in the driven image by using the first segmentation mask, the method further comprises:
performing edge inward corrosion processing on edges of the target part in the first segmentation mask, to obtain a second segmentation mask corresponding to the driven image; and
the extracting the driven target part in the driven image by using the first segmentation mask comprises:
extracting the driven target part in the driven image by using the second segmentation mask.

19. The electronic device according to claim 13, wherein the performing edge inward corrosion processing on edges of the target part in the first segmentation mask, to obtain a second segmentation mask corresponding to the driven image comprises:
performing convolution processing on the edges of the target part in the first segmentation mask by using a convolution kernel of a target size, to obtain a third segmentation mask corresponding to the driven image; and
performing smoothing processing on the edges of the target part in the third segmentation mask by using a blur kernel, to obtain the second segmentation mask corresponding to the driven image.

20. A non-transitory computer-readable storage medium, having program code stored therein, the program code being invoked by a processor to perform an image processing method, the method comprising:
fusing a pre-segmentation mask corresponding to a green screen image and the green screen image to obtain a composite image comprising a foreground region and a background region, the foreground region having a target object, and the target object comprising a target part;
determining a target region comprising the target part in the composite image;
driving the target part in the target region;
determining a target region comprising the driven target part as a driven image;
extracting the driven target part in the driven image according to pixels of the driven image and pixels of the background region; and
generating a target foreground region corresponding to the target object according to the driven target part and a region other than the target part in the foreground region.
